(19) United States
(12) Patent Application Publication
(10) Pub. No.: US 2011/0151783 A1
(43) Pub. Date: Jun. 23, 2011

(54) COMMUNICATION DEVICE AND METHOD THEREOF

(75) Inventors: HOU-WEN LAI, Shenzhen City (CN); WEN-HUI LI, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/916,647

(22) Filed: Nov. 1, 2010

(30) Foreign Application Priority Data
Dec. 17, 2009 (CN) 200910311698.8

(51) Int. Cl. H04B 7/00

(52) U.S. Cl. 455/41.2

(57) ABSTRACT

A communication device between multiple communication networks, comprises an main controller and an audio gateway. The main controller directs the audio gateway to answer a second incoming call through a second communication control unit when a first incoming call has been answered by the audio gateway through a first communication control unit.

### BACKGROUND

1. Technical Field

The present disclosure relates to a communication device, and more particularly to a communication device switchable between multiple communication networks.

2. Description of Related Art

Communication devices operable to communicate in multiple communication networks, such as GSM/CDMA, are popular. In the case of cell phones, decreased or interrupted communications can be improved by switching to an alternative communication network. In addition, BLUETOOH devices are often employed to allow wireless hands-free use of a cell phone. However, BLUETOOTH devices can only manage a phone call of one network type at one time. A need exists in the industry to overcome the described limitations.

### BRIEF DESCRIPTION OF THE DRAWINGS

FIG. 1 is a schematic structural diagram of one embodiment of a communication device as disclosed.

FIG. 2 is a functional diagram of an controller illustrated in FIG. 1.

FIG. 3 is a flowchart illustrating one embodiment of a communication method for dual communication modes.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

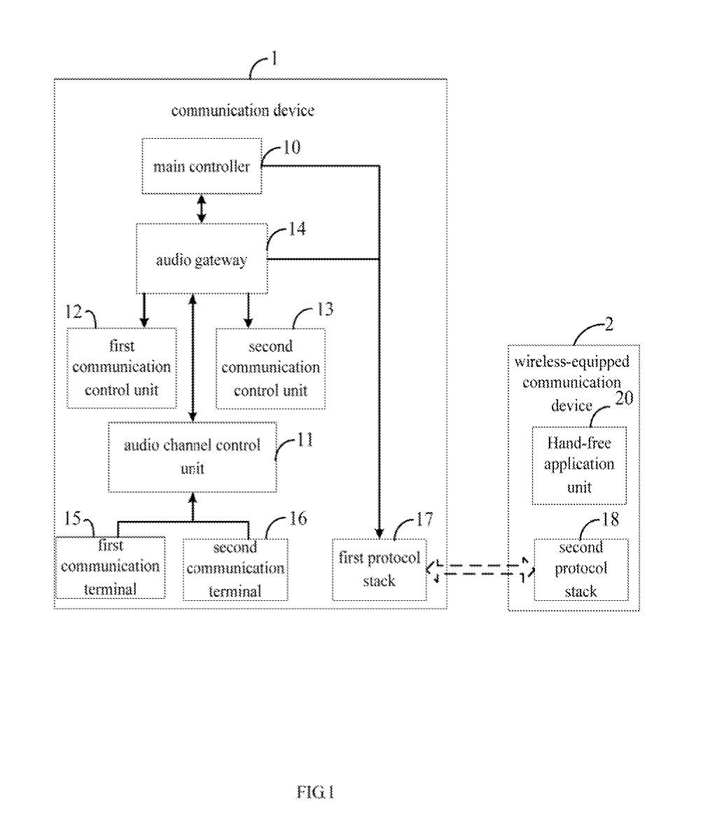

FIG. 1 is a schematic structural diagram of one embodiment of a communication device 1 as disclosed. The communication device 1 includes an main controller 10, an audio channel control unit 11, a first communication control unit 12, a second communication control unit 13, an audio gateway 14, a first communication terminal 15, a second communication terminal 16 and a first protocol stack 17. In one embodiment, the first communication terminal 15 and the second communication terminal 16 can be CDMA, GSM or WCDMA communication terminal. In one embodiment, the audio gateway 14 is a BLUETOOTH audio gateway, and the first protocol stack 17 is a BLUETOOTH protocol stack. The communication device 1 communicates with a wireless-equipped communication device 2 through a second protocol stack 18 included in the hand free answering device 2. Additionally, the wireless-equipped communication device 2 includes a hands-free application unit 20. Via the hands-free application unit 20, the wireless-equipped communication device 2 receives incoming calls from the communication device 1 and executes commands such as answer or disconnecting the incoming call. Respectively, the first protocol stack 17 and the second protocol stack 18 are the communication channels of the communication device 1 and the wireless-equipped communication device 2. Through the first protocol stack 17 and the second protocol stack 18, the communication device 1 is capable of transmitting communication commands and communication data to the wireless-equipped communication device 2. Conversely, the wireless-equipped communication device 2 is also capable of transmitting communication commands and communication data to the communication device 1.

In one embodiment, the first communication terminal 15 and the second communication terminal 16 communicate with two different communication networks respectively, so that the communication device 1 is capable of sending or receiving communicating commands to/from the different two communication networks. For example, the communication network can be a GSM (Global System for Mobile Communication) or CDMA (Code Division Multiple Access) network.

The first communication control unit 12 controls a first audio channel between the communication device 1 and a GSM or CDMA network. The second communication control unit 13 controls a second audio channel built between the communication device 1 and the other of the GSM or CDMA network. The number and types of communication networks disclosed are exemplary, and not limiting in any way, being dynamically amendable and variable with technology. Moreover, through audio gateway 14, the first communication control unit 12 communicates one communication network with the wireless-equipped communication device 2 by the first audio channel. The second communication control unit 13 communicates the other communication network with the wireless-equipped communication device 2 by the second audio channel through the audio gateway 14.

When the communication device 1 receives the incoming call from GSM or CDMA networks, the main controller 10 directs the wireless-equipped communication device 2 to answer the incoming call by commands complying with corresponding protocol stack. In one embodiment, the main controller 10 issues an AT answer command defined in GSM 900/1800 specification to directs the wireless-equipped communication device 2 to answer a SMS(Short Message Service) message. The main controller 10 also administers communication among the communication device 1 and those communication networks in accordance with commands defined in a relevant protocol stack and sent from the hand free answering device 2.

The audio channel control unit 11 directs the audio gateway 14 to connect with the first communication control unit 12 or second communication control unit 13 according to the protocol stack of the incoming call. For instance, if the communication network of the incoming call is connecting through the first communication terminal 15, the audio channel control unit 11 directs the audio gateway 14 to connect with the first communication control unit 12. If through the second communication terminal 16, the audio channel control unit 11 directs the audio gateway 14 to connect with the second communication control unit 13. To answer an incoming call through the wireless-equipped communication device 2, the wireless-equipped communication device 2 sends a command to the audio channel control unit 11 through the audio gateway 14 according to the type of protocol stack complying with the incoming call. The audio gateway 14 switches its audio channel to connect with the first communication control unit 12 or second communication control unit 13 according to which protocol stack meets the protocol stack of the incoming call. In one embodiment, the type of the communication network complying with the incoming call is determined by the gateway that the incoming call passed into the communication device 1 is through the first communication terminal 15 or the second communication terminal 16. In one embodiment, the commands sent from the wireless-equipped communication device 2 to the audio channel control unit 11 are an AT command form complying with Hands-Free Profile 1.5 and further versions.

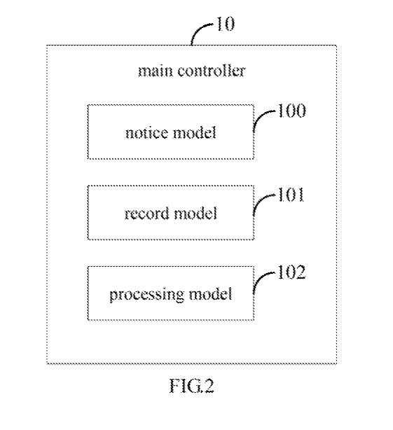

FIG. 2 is a functional diagram of the main controller 10 illustrated in FIG. 1. The main controller 10 includes a notification module 100, a recording module 101 and a processing model 102. The notification module 100 notifies the wireless-equipped communication device 2 to answer an incoming call when the communication device 1 receives the incoming call. The recording module 101 records the communication state of the communication device 1 in accordance with the commands sent from the wireless-equipped communication device 2. For example, when a command to answer incoming calls is received, the recording module 101 records the communication state as an answer state. When the communication device 1 receives no commands to manage the incoming call, the recording module 101 records incoming number as non-answered and manages the incoming call accordingly. To manage the incoming call, the processing model 102 sends commands to the first communication control unit 12 and the second communication control unit 13 according to the communication network type of the incoming call. For instance, when the communication device 1 has already answered a first incoming call through the first communication terminal 15 but receives a second incoming call, a command to answer the second incoming call is sent from the wireless-equipped communication device 2 to the communication device 1. The communication device 1 releases the first incoming call and answers the second incoming call through the second communication terminal 16. After that, the communication device 1 reconnects the first communication terminal 15 with the wireless-equipped communication device 2 to re-answer the first incoming call.

In one embodiment, the command to answer the second incoming call is an AT form AT+CHLD=1 command complying with Hands-Free Profile 1.5 and further versions. The wireless-equipped communication device 2 is a BLUETOOTH wireless-equipped communication device. The audio channel built between the first protocol stack 17 and the second protocol stack 18 is a SCO channel complying with Hands-Free Profile 1.5 and further version.

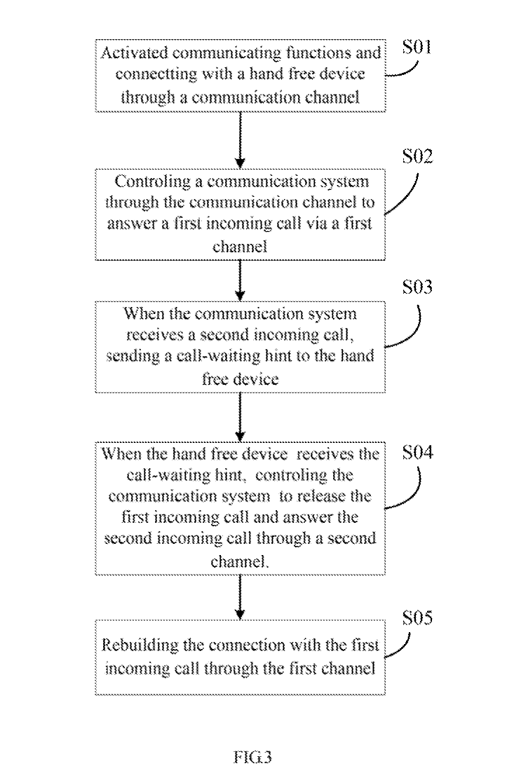

FIG. 3 is a flowchart illustrating one embodiment of a communication method for dual communication modes. Depending on the embodiment, additional blocks in the flow of FIG. 3 may be added, others removed, and the ordering of the blocks may be changed.

In block S01, the communication device 1 activates its communication function and connects with the wireless-equipped communication device 2 through a communication channel.

In block S02, the wireless-equipped communication device 2 through the communication channel directs the communication device 1 to answer a first incoming call via a first channel.

In block S03, when the communication device 1 receives a second incoming call, the communication device 1 sends a call-waiting notice to the wireless-equipped communication device 2.

In block S04, when the wireless-equipped communication device 2 receives the call-waiting hint, the wireless-equipped communication device 2 directs the communication device 1 to release the first incoming call, and answer the second incoming call through a second channel.

In block S05, wireless-equipped communication device 2 rebuilds the connection with the first incoming call through the first channel, so as to answer the first incoming call and the second incoming call at the same time.

In one embodiment of this application, the communication channel is a SCO channel complying with Hands-Free Profile 1.5 and further versions. The first channel and the second channel can be selected from the GSM protocol and CDMA protocol. The wireless-equipped communication device 2 communicates with the communication device 1 through AT form complying with Hands-Free Profile 1.5. The wireless-equipped communication device 2 sends a AT+CHLD 1 command when it answers the second incoming call.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device switchable between multiple communication networks, comprising:
a main controller to direct communication with a first communication control unit and a second communication control unit of the communication device;
an audio gateway controlled by the main controller; and
wherein the main controller directs the audio gateway to answer a second incoming call through the second communication control unit when a first incoming call has been answered by the audio gateway through the first communication control unit.

2. The communication device of claim 1, wherein the main controller releases the first incoming call then re-answers the first incoming call when the audio gateway receives the second incoming call.

3. The communication device of claim 2, wherein the main controller releases the first incoming call when a wireless-equipped communication device sends a command of releasing the first incoming call to the communication device.

4. The communication device of claim 3, wherein the wireless-equipped communication device built a SCO channel, complying with Hands-Free Profile 1.5, with the communication device.

5. The communication device of claim 4, wherein the main controller sends a call-waiting notice to the wireless-equipped communication device when the audio gateway receives the second incoming call.

6. The communication device of claim 4, wherein the first channel is a GSM channel and the second channel is a CDMA channel.

7. A method for switching between multiple communication networks comprising:
connecting with a wireless-equipped communication device through a communication terminal;
answering a first incoming call through a first channel of the communication device by a communication device;
controlling the communication device to release the first incoming call and answer the second incoming call through a second channel of communication device; and
rebuilding the connection with the first incoming call through the first channel so as to answer the first incoming call and the second incoming call at the same time.

8. The method of claim 7 further comprising sending a call-waiting notice to the wireless-equipped communication device when the communication device receives a second incoming call before directing the communication device to release the first incoming call and answer the second incoming call through a second channel.

9. The method of claim 8 further comprising sending a command from the wireless-equipped communication device to direct a communication device through the communication channel to answer a first incoming call via a first channel.

10. The method of claim 7, wherein the communications channel is a SCO channel complying with Hands-Free Profile 1.5 and further version.

11. The method of claim 7, wherein the command is a AT+CHLD 1 command complying with Hands-Free Profile 1.5 and further version.

12. The method of claim 7, wherein the first channel is a GSM channel and the second channel is a CDMA channel.
